(19) United States
(12) Patent Application Publication
(10) Pub. No.: US 2012/0117519 A1
(43) Pub. Date: May 10, 2012

(54) METHOD OF TRANSISTOR MATCHING

(75) Inventor: Ashesh Parikh, Frisco, TX (US)

(73) Assignee: TEXAS INSTRUMENTS INCORPORATED, Dallas, TX (US)

(21) Appl. No.: 13/288,584

(22) Filed: Nov. 3, 2011

Related U.S. Application Data
(60) Provisional application No. 61/409,591, filed on Nov. 3, 2010.

(51) Int. Cl. G06F 17/50

(52) U.S. Cl. 716/53; 716/51

(57) ABSTRACT

A method to reduce transistor-to-transistor Ids variation in an integrated circuit by adjusting transistor gate lengths and optionally transistor widths in the design data base prior to the application of OPC and prior to forming a photomask. A method to reduce transistor-to-transistor Ids variation in an integrated circuit by adjusting transistor gate lengths and optionally transistor widths in the design data base prior to the application of OPC and prior to printing a gate pattern and optionally printing an active pattern on a wafer.

### METHOD OF TRANSISTOR MATCHING

This application claims the benefit of U.S. Provisional Application No. 61/409,591, filed Nov. 3, 2010, the entirety of which is herein incorporated by reference.

### FIELD OF THE INVENTION

This invention relates to the field of integrated circuits. More particularly, this invention relates to a method of adjusting geometries on photolithography reticles to improve transistor matching.

### BACKGROUND OF THE INVENTION

Integrated circuits have been scaled to where some of the geometries now being printed are smaller than the wavelength of light that is used to print them. The light may diffract from the small geometries causing interference effects so that the printed pattern is not the same as the pattern drawn on the photo mask. To compensate for interference effects, optical proximity correction (OPC) software may be used to adjust the geometries on the photomask in such a way that the printed geometry is as close as possible to the design geometry.

Transistor-to-transistor variability may also be increased because some semiconductor manufacturing processes are sensitive to microloading effects due to differences in pattern density. During gate etch the gate profile and critical dimension (CD) on densely spaced gates may be significantly different than the gate profile and CD on isolated gates due to microloading effects.

Typically to compensate for photolithography and process induced geometry changes in a given technology, a phenomenological OPC model is calibrated to test structures that span the transistor length and width space and also calibrated to known lithography hot spots. After layout and prior to writing the photomask, the phenomenological OPC model is run on the design to alter the geometries on the reticle to as closely as possible approximate the geometries in the design database after processing.

Stress effects also change transistor performance. To account for stress effects, typically SPICE models are tuned to test structures spanning the transistor design space that are built with the technology that may include stress inducing processes such SiGe source/drains on PMOS transistors, stress memorization (SMT) on NMOS transistors, and dual stress liners (DSL) on both NMOS and PMOS transistors. These SPICE models may be used to determine the width and length of transistors to be placed in the layout.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to a more detailed description that is presented later.

A method to reduce transistor-to-transistor Ids variation by adjusting transistor gate lengths and optionally transistor widths in the design data base prior to the application of OPC.

### BRIEF DESCRIPTION OF THE DRAWING

FIG. 1 shows the layout of nominal NMOS and PMOS transistors.

FIG. 2 shows the layout of a portion of an integrated circuit illustrating neighborhood differences according to embodiments.

FIG. 3 illustrates a method for calculating cumulative channel stress parallel to the current flow in a target transistor according to embodiments.

FIG. 4 illustrates a method for calculating cumulative channel stress perpendicular to the current flow in a target transistor according to embodiments.

FIG. 5 shows the layout of a transistor gate illustrating neighborhood differences according to embodiments.

FIG. 6 shows the layout of a transistor gate illustrating neighborhood stress segments according to embodiments.

FIG. 7 is an electrical diagram, in schematic form, illustrating a computer system for calculating cumulative channel stress, calculating a stress adjusted target transistor current, and modifying IC design layout data in an integrated circuit according to principles of this invention.

FIG. 8 is a flow diagram illustrating the operation of a computer system for modifying IC design layout data based upon cumulative channel current of tranistors in the IC design layout data, for making a photomask with the modified IC design layout data, and making an IC using the photomask according to principles of this invention.

FIG. 9 is a flow diagram illustrating steps in the method for modifying IC design layout data based upon cumulative channel current of tranistors in the IC design layout data, for making a photomask with the modified IC design layout data, and making an IC using the photomask according to principles of this invention.

### DETAILED DESCRIPTION OF EMBODIMENTS

The present invention is described with reference to the attached figures, wherein like reference numerals are used throughout the figures to designate similar or equivalent elements. The figures are not drawn to scale and they are provided merely to illustrate the invention. Several aspects of the invention are described below with reference to example applications for illustration. It should be understood that numerous specific details, relationships, and methods are set forth to provide an understanding of the invention. One skilled in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Transistor variability results from a number of sources including lithographic interference effects, variability in geometry sizes and differences in gate profiles caused by microloading effects during plasma etching, variability in stress due to differences in transistor-to-transistor neighborhood differences such as active overlap of gate, differences in STI spacing, and differences in spacing to dual stress liner (DSL) borders.

A common method to compensate for lithographic and process induced geometrical differences is to generate a series of test structures that spans the design space and then to calibrate a phenomological OPC model which adjusts the active and gate geometries on the reticle so that they as closely as possible reproduce the layout in the designer data base after the wafer has been fully processed.

Spice models typically are calibrated to transistor test structures that span the transistor width and transistor length space. Stress effects from SiGe source and drains, stress memorization (SMT), and dual stress liners (DSL) are included in the SPICE model since the transistor test structures used to calibrate the SPICE model are formed using these processes. Some SPICE models may also take into account the number of neighboring adjacent gates or dummy gates, but typically do not calculate differences in transistor drive current (Ids) due to differences in stress caused by geometric or neighborhood differences. Design margins are typically increased to enable the circuit to function properly in the presence of transistor-to-transistor Ids variation. In addition the yield distribution may be significantly broadened due to transistor-to-transistor variability. Increasing the design margin may decrease circuit performance and a broader yield distribution may reduce yield driving up cost.

Design margins may be reduced and the yield distribution may be narrowed by providing for a method to reduce transistor-to-transistor variation caused by stress differences according to an embodiment. Transistor geometries on the reticle such as gate length and transistor width may be changed to compensate for stress effects prior to running the OPC software.

The term “nominal transistor” refers to a reference transistor with a reference gate length, active overlap of gate, spacing to an adjacent transistor, and spacing to a dual stress liner (DSL) border. Preferably the nominal transistor is a transistor that occurs most frequently in a design data base. A different nominal transistor may be defined for each different transistor type in a design data base. For example one nominal transistor may be defined for a low vt transistor, another nominal transistor may be defined for a high vt transistor as well as nominal transistors for NMOS and PMOS transistors and for each transistor gate length.

The term “transistor neighborhood differences” refers to differences in structures that are adjacent to a transistor active or transistor gate. For example, differences in the placement of contacts, DSL borders, and adjacent transistors or adjacent active geometries may contribute to transistor neighborhood differences. Transistors with identical gate lengths and transistor widths may have different drive currents (Ids) due to transistor neighborhood differences.

The term “cumulative channel stress” refers the sum total of the stress in the channel resulting from each individual source of stress as STI, DSL border, and active overlap of gate. For example, an STI neighborhood stress equation (N-equation) may be calibrated using data from individual test structures for STI neighborhood effects and a DSL neighborhood stress equation (N-equation) may be calibrated using data from individual test structures for DSL neighborhood effects. The STI and DSL neighborhood effects may be combined to form “cumulative channel stress” for a target transistor which takes into account both STI and DSL stress effects.

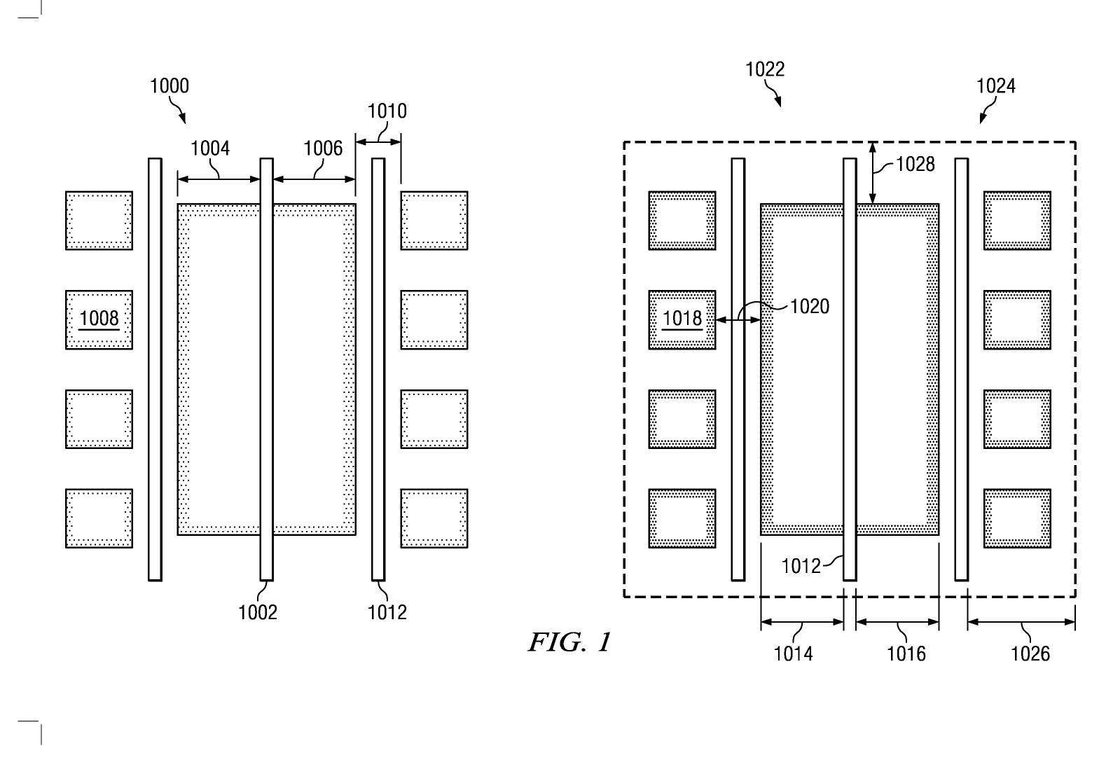

Example nominal NMOS 1000 and PMOS 1022 transistors are illustrated in FIG. 1. NMOS transistor 1000 has equal active overlaps 1004 and 1006 of gate 1002 and the same transistor spacing 1010 to adjacent active geometries 1008 on both sides of the NMOS transistor 1000. No DSL border is close (within 1000 nm for example) to the NMOS transistor. PMOS transistor 1022 has equal active overlaps 1014 and 1016 of gate 1012 and the same transistor spacing 1020 to adjacent active geometries 1018 on both sides of the PMOS transistor 1022.

Dual stress liner (DSL) technology is used to enhance carrier mobility in both NMOS and PMOS transistors. A tensile etch stop dielectric layer is formed over the NMOS transistors to enhance electron mobility and is removed from over the PMOS transistors. A compressive etch stop dielectric layer is formed over the PMOS transistors to enhance hole mobility and is removed from over the NMOS transistors. A DSL border 1024 is formed where the edges of the two stress liner films meet. Drive current of a transistor may be affected by its proximity to the DSL border due to its affect upon carrier mobility. A change in proximity of the DSL border 1026 that is parallel to the carrier flow in the transistor 1022, to the channel of the transistor which is under the gate 1012 may affect Ids differently than a change in proximity of the DSL border 1028 that is perpendicular to the current flow in the transistor channel.

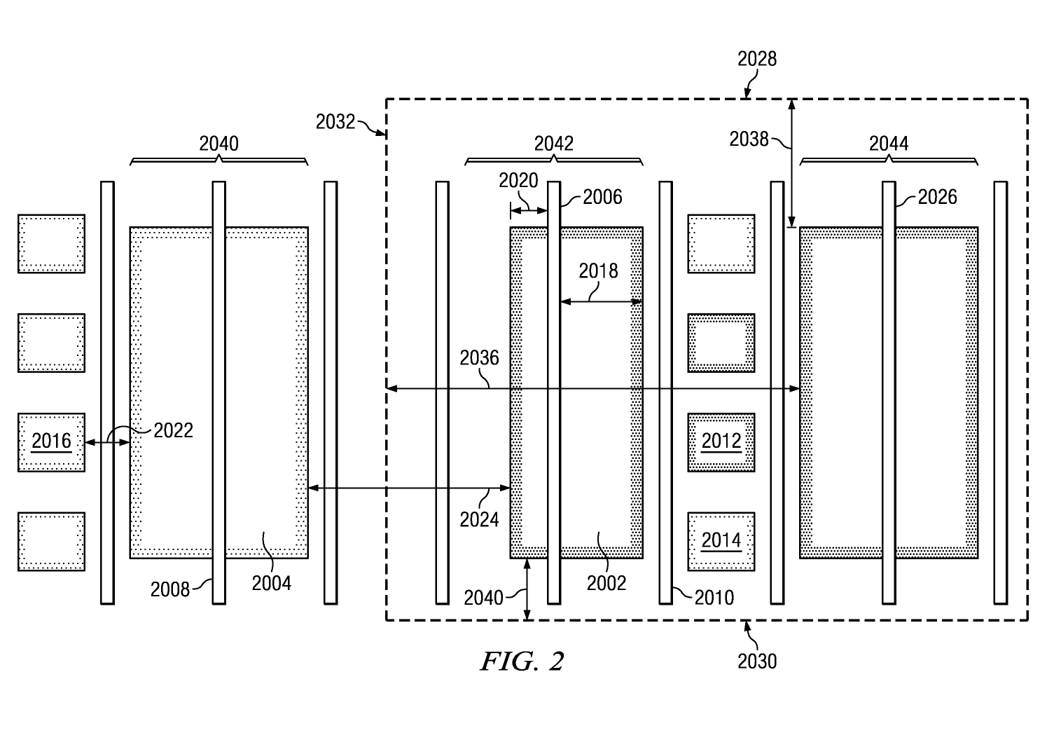

Some of the primary sources of transistor variation due to differences in neighborhood sources of stress are illustrated in FIG. 2. One major source of transistor-to-transistor variability may be due to differences in stress due to differences in active overlap of gate. A transistor with the same gate length and same transistor width as the nominal transistor may have a different Ids due to a difference in active overlap of gate. For example, the gate length and transistor width of PMOS transistor 2042 in FIG. 2 may be the same the gate length and transistor width of PMOS nominal transistor 1022 in FIG. 1 but since active overlap 2020 in FIG. 2 is different than active overlap 1014 on the nominal transistor in FIG. 1 the drive current of PMOS transistor 2042 may be different than nominal PMOS transistor 1022.

Another major source of variability is due to STI stress due to differences in space between the transistor and an adjacent active. The shallow trench isolation (STI) oxide in the isolation space between two adjacent transistors exerts a compressive stress on the active areas that gets transmitted to the channel areas of the transistors. This stress changes the carrier mobility of the transistor which in turn changes the transistor Ids. Larger areas of STI oxide exert more compressive force to the transistor channel. Variation in STI space from one transistor to another transistor or active area causes variability in Ids from one transistor to another even if their gate lengths and transistor widths are identical. For example, even though the gate length and transistor width of NMOS transistor 2040 in FIG. 2 is the same as the nominal NMOS transistor 1000 in FIG. 1, because transistor 2040 to adjacent active space 2024 in FIG. 2 is larger than transistor to adjacent active space 1010 in FIG. 1, Ids of transistor 2040 may be different than Ids of nominal NMOS transistor 1000.

An additional major source of transistor-to-transistor variability due to stress may be due to differences in the space between the transistor and an adjacent DSL border. Electron mobility in NMOS transistors is enhanced when tensile stress is applied to the transistor channel either parallel or perpendicular to the current flow. Hole mobility in PMOS transistors is enhanced by compressive stress applied to the transistor channel perpendicular to the current flow and is enhanced by tensile stress applied to the transistor channel parallel to the current flow. Two transistors with identical gate lengths and transistor widths may have different Ids due to differences in the spacing between the transistor channels and DSL border. For example, even though the gate length and transistor width of transistor 2044 in FIG. 2 is identical to the gate length and transistor width of transistor 1012 in FIG. 1, because the transistor 2044 to DSL border spaces 2036 and 2038 are different than the transistor 1022 to DSL border spaces 1026 and 1028, the Ids of transistor 2044 may be different than the Ids of the nominal PMOS transistor 1022.

A method of changing transistor geometries on photomasks to reduce the transistor-to-transistor variability due to stress is described below. In addition to changing transistor geometries on photomasks to compensate for lithographic and process induced geometric effects, transistor geometries on photomasks are changed to compensate for Ids variation due to transistor-to-transistor neighborhood difference effects. Transistor geometries in the design data base are first changed for neighborhood difference effects before the OPC corrections are applied. Reticles are then formed using the design data base and photoresist patterns are printed on wafers using the reticles to form an integrated circuit.

Test structures may be designed to individually evaluate the impact of each of the sources of stress mentioned above. For example, NMOS and PMOS transistor test structures with active overlaps of gate that span the active overlap of gate design space may be used to determine the stress in the channel as a function of active overlap of gate. In these test structures the other neighborhood sources of stress variation such as active-to-active space and transistor to DSL space may be held constant.

Similarly test structures may be designed for other sources of transistor-to transistor Ids differences such as channel stress as a function of STI space width. Transistor-to-DSL border test structures may be designed to span the transistor-to-DSL border space. These test structures may be used to calibrate equations that give the stress in the transistor channel versus neighborhood differences such as STI space and transistor-to-DSL border space. Test structures that vary two or more of the stress variables also may be designed to determine if any cross term coefficients are needed in these equations. For example to determine if a cross term that is a function of active overlap of gate and a function of transistor space-to-DSL border is needed.

Equations that relate stress in the channel to carrier mobility and to transistor drive current (Ids) are well known and may be used to calculate the transistor performance once the cumulative channel stress is known.

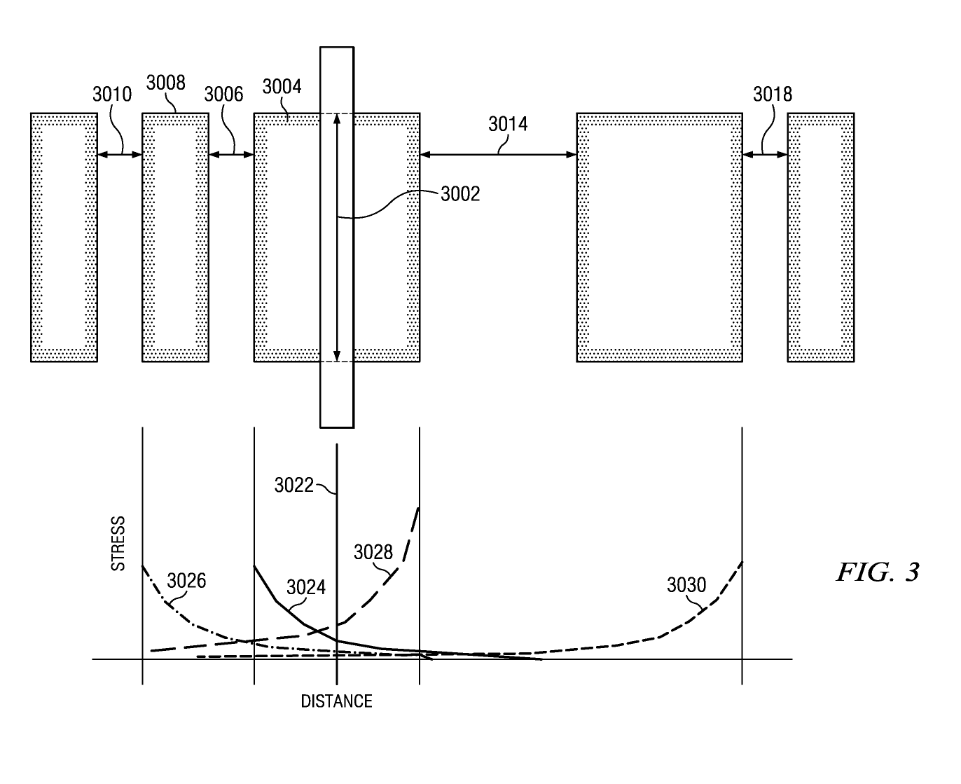

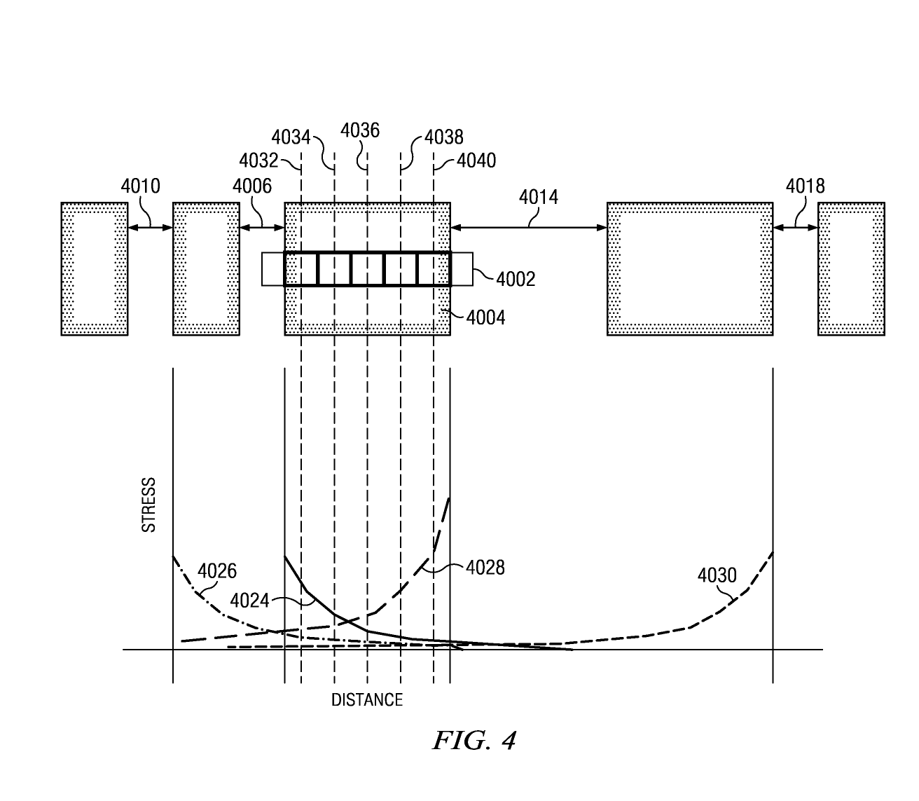

Compressive stress from shallow trench isolation (STI) geometries next to active are used to illustrate an embodiment in FIGS. 3 and 4. FIG. 3 illustrates how the stress from multiple individual adjacent spaces next to a transistor 3002 may be added to determine the cumulative parallel stress in the transistor channel. Parallel stress is the stress that is parallel to the current flow in the transistor channel. The compressive stress from the STI to the left of active geometry 3004 is given by the curve 3024 in the stress graph. This stress is from the STI dielectric in space 3006 between active geometries 3004 and 3008. Likewise the stress from the STI dielectric in space 3010 is given by curve 3026. The larger space 3014 on the right side results in higher compressive stress as shown by curve 3028. Stress from STI space 3018 is almost completely dissipated at the transistor channel 3002 as shown by curve 3030. The cumulative channel stress from each of the STI geometries may be determined by summing the individual stress values where each of the individual stress curves 3024, 3026, 3028, and 3030 crosses the channel region, 3022.

FIG. 4 illustrates how the stress from multiple individual adjacent spaces perpendicular to the current flow in transistor 4002 may be added to determine the cumulative perpendicular stress in the transistor channel. The compressive stress from the STI 4006 adjacent to transistor 4002 is given by the curve 4024 in the stress graph. Likewise the stress from the STI dielectric in space 4010 is given by curve 4026. The larger space 4014 on the right side results in higher compressive stress as shown by curve 4028. Stress from STI space 4018 is almost completely dissipated at the transistor channel 4002 as shown in sress curve 4030. Because the stress is changing across the transistor channel region, the channel region may be divided into multiple subregions called stress segments, and a cumulative stress calculated for each stress segment. The cumulative stress in subregion 4032 may be determined by summing the individual stress values where each of the individual stress curves 4024, 4026, 4028, and 4030 crosses the stress segment, 4032. In like manner the cumulative stress may be calculated for each of the other stress segments, 4034, 4036, 4038, and 4040. More or fewer stress segments may be used. Stress that is a function of other stress producing geometries such as DSL border may be treated in a similar manner and included in the cumulative active stress by adding their contributions.

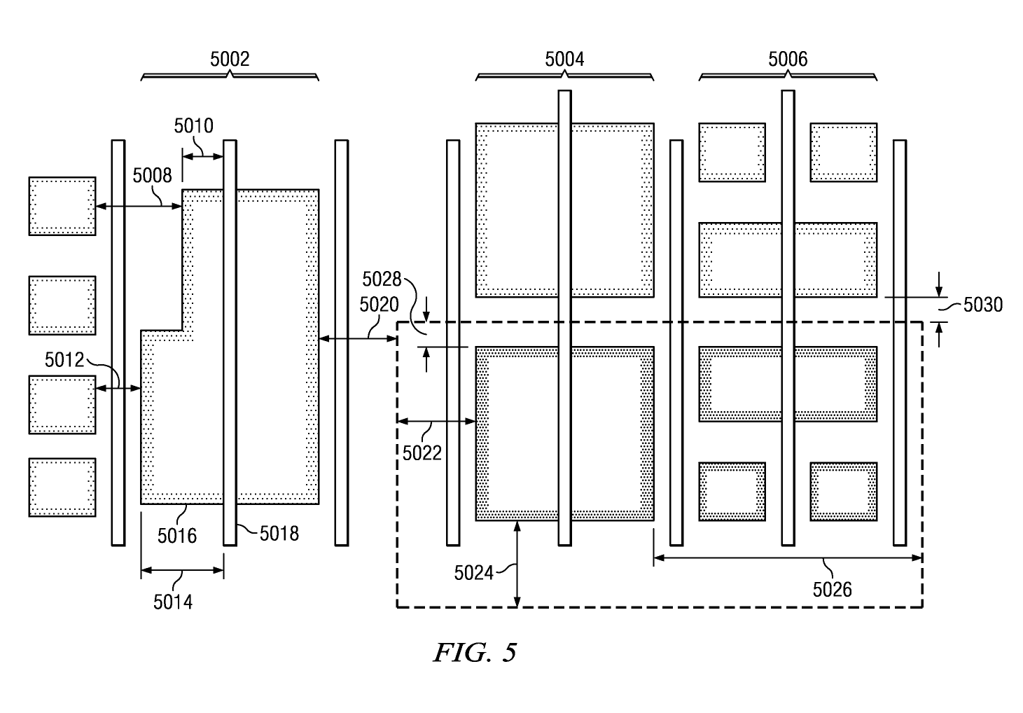

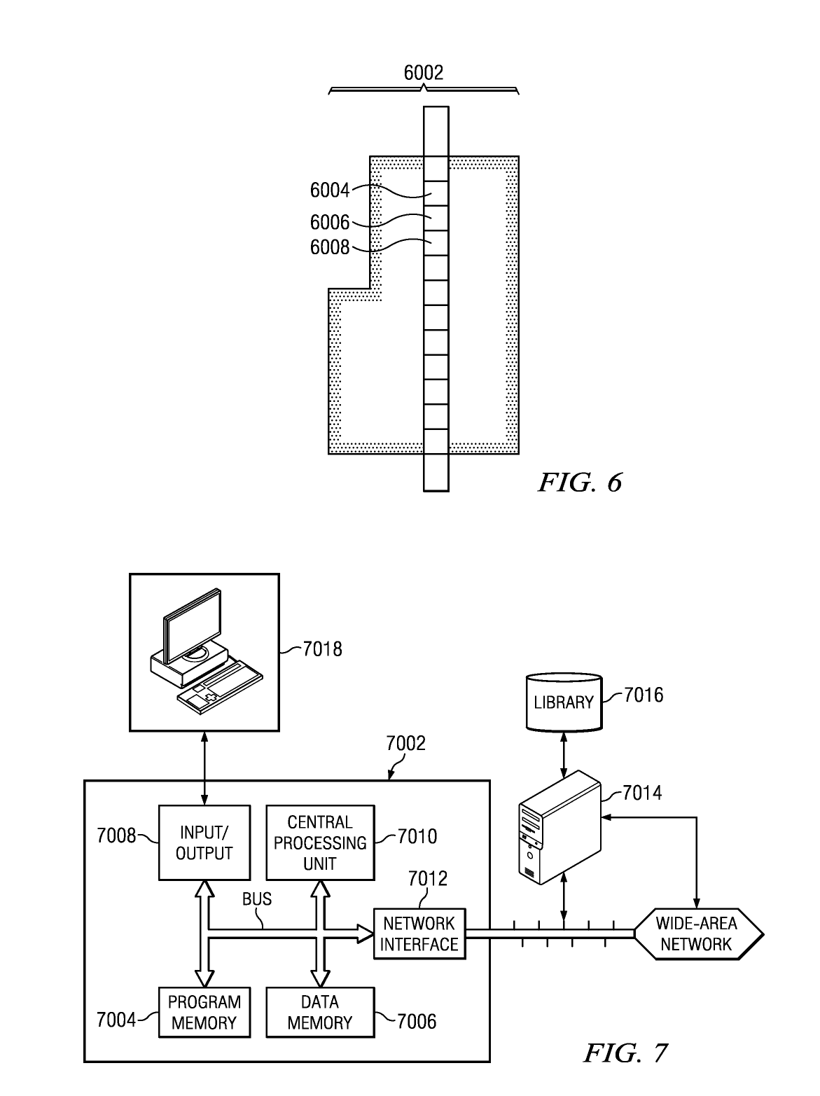

The active overlap of gate, transistor-to-active space, and transistor-to-DSL border space may not be the same along the width of transistors in a design data base. As illustrated in FIG. 5 the active overhang 5010 of gate 5018 for the top half of transistor 5002 is different than the active overhang 5014 of gate 5018 for the bottom half. Similarly, the transistor-to-adjacent active space 5008 for the top half of transistor 5002 is different than the transistor-to-adjacent active space 5012 for the bottom half. Additionally the transistor-to-DSL border space 5020 for the bottom half of NMOS transistor 5002 is different than the transistor-to-DSL border space for the top half. The DSL border space 5022 perpendicular to the current flow in PMOS transistor, 5004, is different than the transistor-to DSL border space 5026, and the DSL border space 5024 parallel to the current flow is different than the transistor-to-DSL border space 5028. To account for these differences in both the stress parallel to transistor channel and stress perpendicular to transistor channel directions, the channel may be divided into stress segments for stress calculation for both the parallel and perpendicular stress contributions.

A procedure similar to the procedure presented in FIG. 4 may be used to calculate the stress in the channel for non uniform geometries. The channel of the transistor 6002 may be divided into a number of neighborhood stress segments, 6004, 6006, 6008 which span the width of the channel. The stress as a function of neighborhood differences may be calculated for each neighborhood stress segment using the N-equations and then the Ids of the neighborhood stress segments may be summed together to give the total transistor Ids. The number of neighborhood stress segments may be fixed or may be adjusted as needed to perform the calculations. The cumulative perpendicular channel stress and the cumulative parallel channel stress may be calculated for each stress segment.

One embodiment method is to calibrate neighborhood equations (N-equations) that calculate the cumulative stress in the channel of a target transistor as a function of each neighborhood difference variable. For each neighborhood difference variable, a one dimensional equation may be used to calculate the cumulative parallel channel stress and another one dimensional equation may be used to calibrate the cumulative channel stress. Since stress is linearly additive, the individual stresses may be added together giving the resultant stress in the channel from the combination of the stresses. An N-equation that relates stress to mobility may be used to calculate carrier mobility in the channel and well known equations that relate carrier mobility to Ids may then be used to calculate Ids. The Ids of each stress segment 6004, 6006, 6008, etc. may be calculated and then added together to give the stress adjusted target transistor Ids. This stress adjusted Ids may be compared to the nominal transistor Ids. The target transistor gate length or the target transistor width may then be adjusted in the database to match the transistor Ids to the nominal transistor Ids. In the event the gate length of the target transistor would be reduced to match the nominal transistor Ids, Ioff of the transistor may be increased unacceptably. To avoid increased Ioff, the width of the transistor may be optionally increased to avoid reducing the gate length.

FIG. 7 illustrates the construction of a system used to modify physical layout data of integrated circuit interconnection layers and via layers according to an embodiment of the invention. In this example, the layout modification system is as realized by way of a computer system including workstation 7002 connected to server 7014 by way of a network through network interface 7012. Of course, the particular architecture and construction of a computer system useful in connection with this invention can vary widely. For example, the interconnect and via layout modification system may be realized by a single physical computer, such as a conventional workstation or personal computer, or alternatively may be a computer system implemented in a distributed manner over multiple physical computers. Accordingly, the generalized architecture illustrated in FIG. 7 is provided by way of example only.

As shown in FIG. 7, workstation 7002 includes central processing unit (CPU) 7010, coupled to the system bus BUS. Also coupled to system bus BUS is input/output interface 7008 which refers to those interface resources by way of which peripheral functions 7018 (e.g., keyboard, mouse, display, etc.) communicate with the other constituents of workstation 7002. CPU 7010 refers to the data processing capability of workstation 7002, and as such may be implemented by one or more CPU cores or co-processing circuitry. The particular construction and capability of central processing unit 7010 is selected according to the application needs of workstation 7002. In the architecture of layout modification system according to this example, program memory 7004 and data memory 7006 are coupled to the system bus BUS. The workstation 7002 and server 7014 may also be coupled to a library 7016 which may store programs, data, and integrated circuit layout patterns such as interconnect layout data and via layout data.

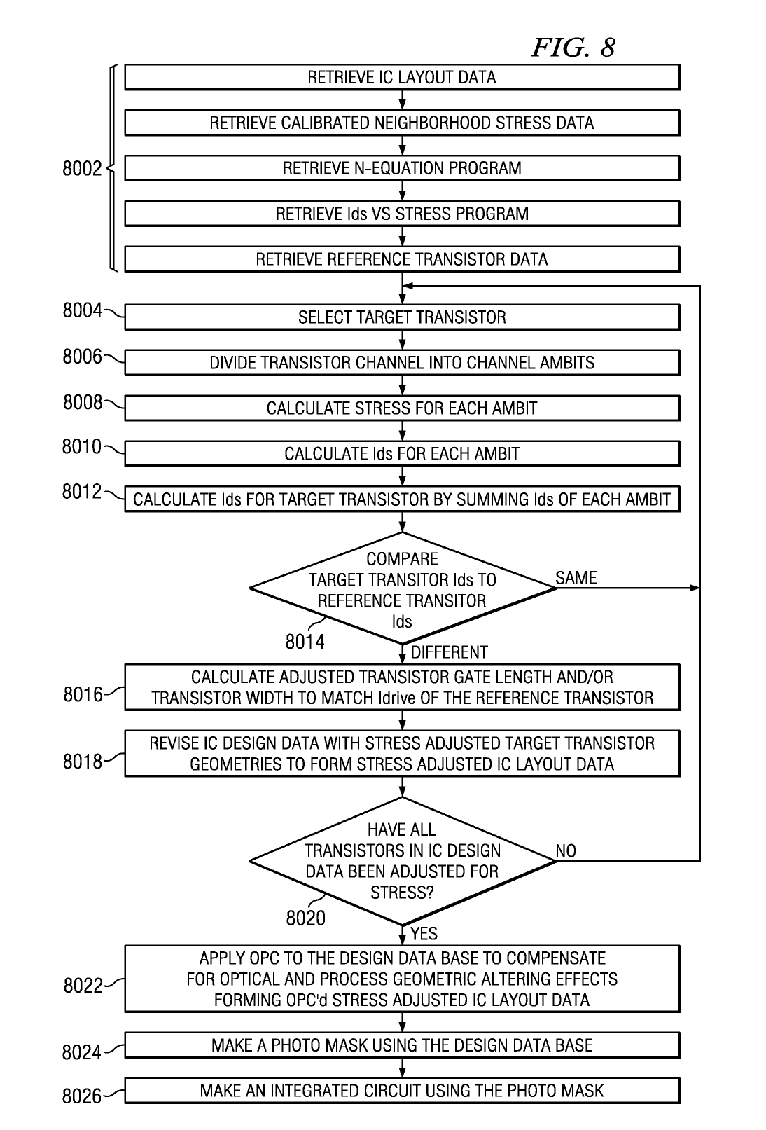

FIG. 8 illustrates an embodiment process flow. After the designers complete a design layout for the integrate circuit, the workstation 7002 may retrieve the design layout data, neighborhood stress data, and reference transistor data from the server 7014 or a data storage area such as the library 7016 in FIG. 7. The workstation 7002 may also retrieve programs to calculate the parallel and perpendicular cumulative channel stress for each stress segment in the channel of a target transistor and also to calculate a stress adjusted drive current (Ids) for the target transistor as shown in step 8002 of FIG. 8.

In step 8004 a target transistor is selected from the design layout data and the channel of the target transistor is divided into stress segments in step 8006. The size of an stress segment may be fixed or may be determined by the neighborhood around the target transistor. For example if the neighborhood of the target transistor is completely symmetrical and constant across the entire channel length of the transistor only one stress segment may be required for calculation of the parallel cumulative channel stress. If there are X changes in the neighborhood across the length of the target transistor then there may be X stress segments to calculate the parallel cumulative channel stress. In an example embodiment a fixed stress segment size is used to calculate both the parallel and the perpendicular cumulative channel stress.

In step 8010, the stress adjusted drive current is calculated for each stress segment based upon the cumulative channel stress for each stress segment.

In step 8012 the stress adjusted drive current for the target transistor is calculated by summing the stress adjusted drive current of each stress segment.

In step 8014 the stress adjusted drive current of the target transistor is compared to the drive current of a reference transistor. In an example embodiment the stress adjusted drive current per unit target transistor width of the target transistor is compared to the drive current per unit reference transistor width. If the two drive currents are the same then no adjustment is needed so another target transistor is selected and steps 8006 through 8014 are repeated.

If on the other hand the stress adjusted drive current of the target transistor is different than the drive current of the reference transistor, a calculation is performed in step 8016 to determine how much the gate of the target transistor needs to be adjusted so that the drive current per unit channel width of the target transistor will match the drive current per unit channel width of the reference transistor. If the drive current of the target transistor needs to be increased, it may be undesirable to reduce the gate length of the target transistor because this may cause an increase in off current. In this instance, the channel width of the target transistor may be increased to increase drive current.

After the required adjustment to the gate length or width of the target transistor is determined in step 8016, the gate or active IC layout in the design data base is changed with the required adjustments.

In step 8020 a check is performed to see if all transistors in the IC layout have been evaluated for the impact of neighborhood stress. If not, the program in the workstation 7002 proceeds to step 8004 and selects another target transistor.

When all transistors have been adjusted for neighborhood effects, the workstation 7002 may store the IC layout data on the server 7014 or in the data storage 7016.

Alternatively, the workstation may retrieve an OPC program from the server 7014 and adjust the geometries in the IC layout data to compensate for optical and process geometric altering effects. Dummy features may also be added to the IC layout data to enable more uniform processing.

As shown in step 8024, the IC layout data that has first been adjusted for neighborhood effects and then adjusted for optical an process geometric altering effects may then be used to generate photomasks.

These photomasks may then be used to build an integrated circuit with reduced transistor-to-transistor variation. Reduced transistor-to-transistor variation enables designers to design to tighter specifications which in turn enables a higher performance integrated circuit to be manufactured. In addition, reduced transistor-to-transistor variation in the IC results in higher manufacturing yield of the IC.

The embodiments are illustrated using transistor variation caused by differences in transistor stress neighborhood. Other sources of transistor-to-transistor variation such as number of contacts and contact placement may also be modeled and Ids may also be corrected using the embodiment methods. When a contact is etched it may remove part of the stress liner reducing the stress on the gate and therefore reducing the stress enhancement of carriers in the channel. For example, a transistor may have the same gate length and transistor width as the nominal transistor but have a different number of contacts to active or a different placement of the contacts causing the Ids of the transistor to differ from the nominal transistor. Those skilled in the art may know of other sources of transistor variation that may be corrected using these embodiments.

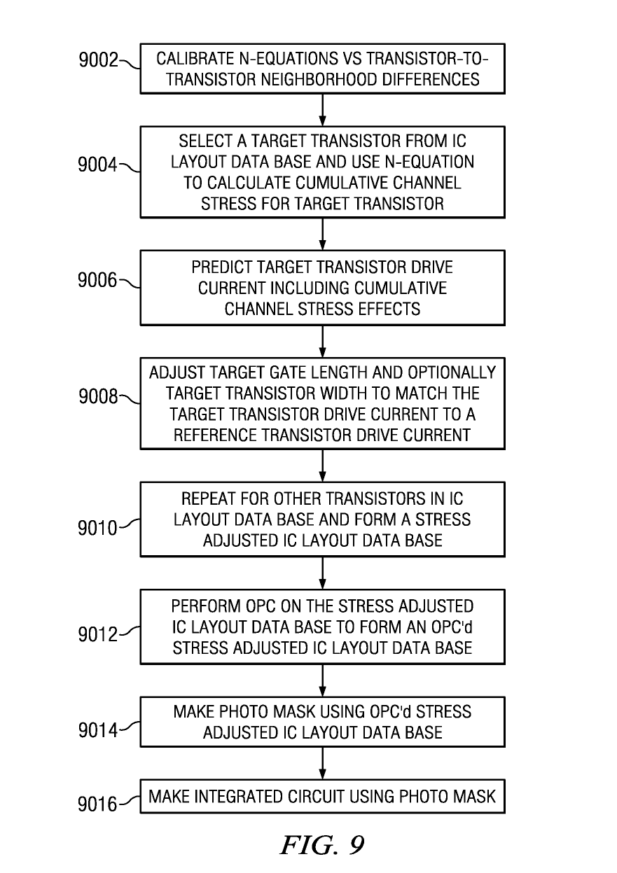

Another example embodiment flow is shown in FIG. 9. Neighborhood equations (N-equations) which calculate the cumulative channel stress for a transistor may be calibrated to a set of transistors on a testchip. For example a first set of testchip transistors with various active overhang of gate may be used to calibrate the N-equations for active overhang of gate stress effects. A second set of testchip transistors with differing STI spaces to adjacent active geometries may be used to calibrate the N-equations for STI stress effects. A third set of testchip transistors with differing DSL boarder to testchip channel spaces may be used to calibrate the N-equations for DSL stress effects. A fourth set of testchip transistors with differing number of contacts and differing number of contact-to-gate spacing may be used to calibrate the N-equations for contact neighborhood effects. Those skilled in the art will know of other neighborhood effects that may be used to prepare a set of test transistors on the testchip.

The calibrated N-equations may then be used to calculate the cumulative channel stress of a test transistor in IC layout data based upon the test transistor neighborhood as shown in step 9004.

In step 9006, well known equations such as SPICE may be used to calculate the stress adjusted drive current of the test transistor including the cumulative channel stress calculated using the calibrated N-equations.

This stress adjusted drive current may then be compared to a reference drive current in step 9008 and the gate length and/or the transistor width of the test transistor may be adjusted to match the drive current of the test transistor to the reference transistor.

Steps 9004 through 9008 may be repeated for each transistor in the IC layout data base and stress adjusted geometries may be formed for each transistor. The stress adjusted geometries of the test transistor may be used to form a stress adjusted IC layout data base in step 9010.

In step 9012 OPC may be applied to the stress adjusted IC layout data base to form an OPC'd stress adjusted IC layout data base.

In step 9014 this OPC'd stress adjusted IC layout data base may be used to make a photo mask and in step 9016 this photomask may be used to make an integrated circuit.

While various embodiments of the present invention have been described above, it should be understood that they have been presented by way of example only and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A process of forming an integrated circuit, comprising the steps:
operating a computer system comprising the steps of:
retrieving IC layout data of said integrated circuit into said computer system;
retrieving calibrated neighborhood stress data into said computer system;
retrieving a first computer program into said computer to calculate a cumulative channel stress for a transistor;
retrieving a second program into said computer that calculates a drive current for said target transistor with said cumulative channel stress as an input;
retrieving a reference drive current into said computer system;
selecting a first target transistor from said IC layout data;
calculating said cumulative channel stress for said target transistor using said first computer program;
calculating said drive current using said second program;
comparing said drive current to said reference drive current;
adjusting at least one of a gate length and a transistor width of said target transistor until said drive current of said target transistor is approximately equal to said reference drive current;
adjusting said gate length and said transistor width of said target transistor in said IC layout data to form stress adjusted IC layout data;
selecting additional target transistors and repeating said step of calculating said cumulative channel stress, said step of calculating said drive current; said step of comparing said drive current, said step of adjusting at least one; and said step of adjusting said gate length for additional transistors in said IC layout data;
and
saving said stress adjusted IC layout data;
making a photomask using said stress adjusted IC layout data; and
making said integrated circuit using said photolithography reticle.

2. The process of claim 1 further comprising the steps of:
saving said stress adjusted IC layout data to a data storage device;
retriving said stress adjusted IC layout data from said data storage device into said computer system;
applying OPC to said stress adjusted IC layout data; and
saving said OPC'ed stress adjusted IC layout data.

3. The process of claim 1 where said photomask is at least one of a gate photomask.

4. The process of claim 1 where said step of calculating said cumulative channel stress includes at least one of active overhang of gate stress, STI stress, DSL boarder stress, and contact stress.

5. The process of claim 1 where said step of calculating said cumulative channel stress further comprises:
dividing a channel area of said target transistor into at least two stress segments; and
calculating a cumulative channel stress for each stress segment; and
where said step of calculating said drive current further comprises:
calculating an stress segment drive current for each stress segment; and
calculating said drive current by summing said stress segment drive current for each stress segment.

6. The process of claim 5 where said step of calculating said cumulative channel stress further comprises:
calculating a parallel cumulative channel stress for each stress segment;
calculating a perpendicular channel stress for each stress segment; and
summing said perpendicular channel stress and said parallel cumulative channel stress for each stress segment.

7. A process of operating a computer system to reduce transistor-to-transistor variability in IC, comprising the steps:
retrieving IC layout data of said integrated circuit into said computer system;
retrieving calibrated neighborhood stress data into said computer system;
retrieving a first computer program into said computer to calculate a cumulative channel stress for a transistor;
retrieving a second program into said computer that calculates a drive current fo said target transistor with said cumulative channel stress as an input;
retrieving a reference drive current into said computer system;
selecting a first target transistor from said IC layout data;
calculating said cumulative channel stress for said target transistor using said firs computer program;
calculating said drive current using said second program;
comparing said drive current to said reference drive current;
adjusting at least one of a gate length and a transistor width of said target transistor until said drive current of said target transistor is approximately equal to said reference drive current;
adjusting said gate length and said transistor width of said target transistor in said IC layout data to form stress adjusted IC layout data;
selecting additional target transistors from said IC layout date and repeating said step of calculating said cumulative channel stress, said step of calculating said drive current; said step of comparing said drive current, said step of adjusting at least one, and said step of adjusting said gate length for additional transistors in said IC layout data; and
saving said stress adjusted IC layout data.

8. The process of claim 7 further comprising the steps of:
saving said stress adjusted IC layout data to a data storage device;
retrieving said stress adjusted IC layout data from said data storage device into said computer system;
applying OPC to said stress adjusted IC layout data to form OPC'd stress adjusted IC layout data; and
making a photomask using said OPC'd stress adjusted IC layout data.

9. The process of claim 7 where said photomask is at least one of a gate photo mask and an active photo mask.

10. The process of claim 7 where said step of calculating said cumulative channel stress includes at least one of active overhang of gate stress, STI stress, and DSL boarder stress.

11. The process of claim 7 where said step of calculating said cumulative channel stress further comprises:
dividing a channel area of said target transistor into at least two stress segments; and
calculating a cumulative channel stress for each stress segment; and
where said step of calculating said drive current further comprises:
calculating an stress segment drive current for each stress segment; and
calculating said drive current by summing said stress segment drive current for each stress segment.

12. The process of claim 11 where said step of calculating said cumulative channel stress further comprises:
calculating a parallel cumulative channel stress for each stress segment;
calculating a perpendicular channel stress for each stress segment; and
summing said perpendicular channel stress and said parallel cumulative channel stress for each stress segment.

13. A process of forming an integrated circuit, comprising the steps:
providing IC layout data for said integrated circuit;
performing a first adjustment of at least one of a gate length geometry and active width geometry of a transistor in said IC layout data to reduce transistor-to-transistor drive current variability due to transistor-to-transistor active overlap of gate differences;
performing a second adjustment of said at least one of said gate length geometry and said active width geometry in said IC layout data to additionally reduce transistor-to-transistor drive current variability due to STI stress differences; and
making a photomask using said IC layout data; and
printing a photolithography pattern on a wafer during a manufacturing process using said photomask to form said integrated circuit.

14. The process of claim 13 where said photolithography pattern is at least one of a gate pattern and an active pattern.

15. The process of claim 13 further comprising the steps:
performing a third adjustment of at least one of a gate length geometry and active width geometry of a transistor in said IC layout data to reduce transistor-to-transistor drive current variability due to DSL border stress differences.

16. The process of claim 13 further comprising the steps:
performing a third adjustment of at least one of a gate length geometry and active width geometry of a transistor in said IC layout data to reduce transistor-to-transistor drive current variability due to a differences in contacts including differences in the number of contacts and differences in the spacing of said contacts to a transistor of said transistor.

17. The process of claim 13 where said step of performing a first adjustment includes matching a drive current of said transistors to a reference transistor drive current.

18. A process of forming an integrated circuit, comprising the steps:
providing IC layout data for said integrated circuit;
calibrating cumulative channel stress equations that predict a drive current of a transistor as a function of a transistor neighborhood differences using a series of test transistors with neighborhood differences on a testchip;
performing an adjustment to at least one of a gate geometry and an active width geometry of a target transistor in said design data base to match a drive current of said target transistor to a drive current of a reference transistor where said step of performing said adjustment uses predictions from said equations; and
forming a photomask using said design database.
